(19) United States
(12) Patent Application Publication
(10) Pub. No.: US 2022/0007691 A1
(43) Pub. Date: Jan. 13, 2022

(54) METHODS AND SYSTEMS FOR A FRESH FOOD ULTRA-VIOLET STERILIZATION DEVICE

(71) Applicant: ASRAR NABIL M DAMDAM, San Mateo, CA (US)

(72) Inventor: ASRAR NABIL M DAMDAM, San Mateo, CA (US)

(21) Appl. No.: 17/327,763

(22) Filed: May 24, 2021

Related U.S. Application Data
(63) Continuation-in-part of application No. 17/109,143, filed on Dec. 2, 2020, now abandoned.
(60) Provisional application No. 62/944,623, filed on Dec. 6, 2019.

(51) Int. Cl. A23L 3/28; A23L 3/00; G06Q 10/08

(52) U.S. Cl. CPC A23L 3/28; A23L 3/003; H04W 84/12; G06Q 10/087; A23L 3/001

(57) ABSTRACT

In one aspect, a method for automating operation of an ultraviolet (UV) light lamp and vacuum pump includes the step of providing a UV light lamp in the ultra-violet food sterilization device. The method includes providing a vacuum pump in the ultra-violet food sterilization device; detecting that a food-item container is placed inside the ultra-violet food sterilization device. The food-item container is a material that is transparent to UV light. The food-item container includes a vacuum-pump receptacle. The method includes turning on a UV light lamp for a specified period of time. With a vacuum pump, the method generates a specified partial vacuum within the food-item container.

### CLAIM OF PRIORITY

This application is a continuation in part of U.S. patent application Ser. No. 17/109,143, filed on 2 Dec. 2020 and titled METHODS AND SYSTEMS FOR A PORTABLE FRESH FOOD ULTRA-VIOLET STERILIZATION DEVICE. U.S. patent application Ser. No. 17/109,143 claims priority to U.S. Provisional Patent Application No. 62/944,623, filed on 6 Dec. 2019 and titled METHODS AND SYSTEMS FOR A PORTABLE FRESH FOOD ULTRA-VIOLET STERILIZATION DEVICE. These applications are hereby incorporated by reference in their entirety.

### SUMMARY OF THE INVENTION

In one aspect, a method for automating operation of an ultraviolet (UV) light lamp and vacuum pump includes the step of providing a UV light lamp in the ultra-violet food sterilization device. The method includes providing a vacuum pump in the ultra-violet food sterilization device; detecting that a food-item container is placed inside the ultra-violet food sterilization device. The food-item container is a material that is transparent to UV light. The food-item container includes a vacuum-pump receptacle. The method includes turning on a UV light lamp for a specified period of time. With a vacuum pump, the method generates a specified partial vacuum within the food-item container.

### BRIEF DESCRIPTION OF THE DRAWINGS

FIG. 1 illustrates an example process for automating operation of a UV light lamp, according to some embodiments.

FIGS. 2 A-C illustrate an example ultra-violet food sterilization device, according to some embodiments.

FIGS. 3 A-B illustrate another example ultra-violet food sterilization device, according to some embodiments.

FIG. 4 illustrates a stacking of three ultra-violet food sterilization devices, according to some embodiments.

FIG. 5 illustrates an example schematic of an ultra-violet food sterilization device, according to some embodiments.

FIG. 6 illustrates an example process for operating an ultra-violet food sterilization device, according to some embodiments.

FIG. 7 depicts an exemplary computing system that can be configured to perform any one of the processes provided herein.

FIG. 8 illustrates an example horizontal configuration of ultra-violet food sterilization devices, according to some embodiments.

The Figures described above are a representative set and are not an exhaustive with respect to embodying the invention.

### DESCRIPTION

Disclosed are a system, method, and article of fresh food ultra-violet sterilization device. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Electrical ballast is a device placed in series with a load to limit the amount of current in an electrical circuit.

Cloud computing can involve deploying groups of remote servers and/or software networks that allow centralized data storage and online access to computer services or resources. These groups of remote serves and/or software networks can be a collection of remote computing services.

Ultraviolet (UV) is electromagnetic radiation with wavelength from 10 nm to 400 nm.

Vacuum pump is a device that draws gas molecules from a sealed volume in order to leave behind a partial vacuum. A vacuum pump can generate a relative vacuum within a specified capacity. Example vacuum pumps include, inter alia: a positive displacement pump; a momentum transfer pump; a regenerative pump; an entrapment pump; etc.

Virtual assistant Al is a software agent that can perform tasks or services for an individual based on commands or questions.

### Exemplary Methods

In one example, the ultra-violet food sterilization device can be a portable device. The ultra-violet food sterilization device can be used to increase the lifetime fresh-food or underneath kitchen cabinets to disinfect food, water bottles, kitchen tools outside of a refrigerator. It is noted that ultraviolet (UV) light has an inimical effect on the bacteria the causes the food spoilage. For example, ultra-violet food sterilization device can use the Band-C of the UV light that ranges between 200 nm-280 nm to destroying the DNA of different kinds of bacteria and viruses that are responsible for the food spoilage and foodborne illnesses. The ultra-violet food sterilization device is specifically designed for the use of households and restaurants. The ultra-violet food sterilization device can be a small, portable, and rechargeable.

In one example, the ultra-violet food sterilization device can use ultraviolet light and the creation of a vacuum (e.g. a partial vacuum). Food items to be sterilized and stored can be placed into transparent container used to store food. The food items can be placed in a transparent container and then inside the ultra-violet food sterilization device. In one example, the ultra-violet food sterilization device can use a UV light source. The ultra-violet food sterilization device can include a vacuum pump. It is noted that each time the transparent container is opened to access the food times, the process (e.g. UV sterilization and/or generating a partial vacuum) can be implemented. In one example, the UV sterilizer system can use a 36-watt 254 nm UV bulb. The vacuum pump can generate a partial vacuum in the transparent container within around thirty (30) seconds.

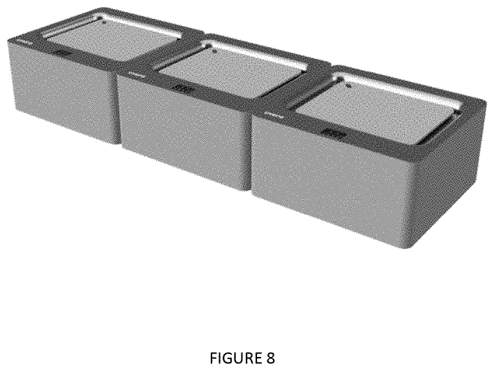

It is noted that in some examples can be implemented in industrial and/or restaurant settings. In the restaurant setting, a plurality of ultra-violet food sterilization device can be stacked and interconnected. A plurality of ultra-violet food sterilization devices can also be connected horizontally (e.g. see FIG. 8 infra).

The ultra-violet food sterilization device can include a rechargeable power source(s). Stacked ultra-violet food sterilization devices can be electronically coupled to share their respective rechargeable power sources. For example, the plurality of ultra-violet food sterilization device can be stacked on top of each other. The bottom of each ultra-violet food sterilization device and/or a specialized bottom ultra-violet food sterilization device can include four wheels. In this way, a system of stacked ultra-violet food sterilization devices can be rolled around a work area of a restaurant for ease of access.

In some example, a non-transparent tape or other feature can be used to block UV light exposure outside of device during the sterilization process. Accordingly, the transparent container can have a non-transparent side that faces outward toward the user when the ultra-violet food sterilization device is in use.

Labels can be placed on the transparent container. The transparent container can have a vacuum outlet. Containers can have QR code that is used to identify the container in a user's food storage system. A mobile device and/or other application can be used to record the container's QR code, date of first sterilization, food stored therein, other relevant data, etc. In this way, the ultra-violet food sterilization device can be used to help with inventory management and expiry date of food items. In some example, mobile devices can be used to obtain digital images of the food items. It is noted that ultra-violet food sterilization device can also include digital cameras for obtaining images of food items as well. Ultra-violet food sterilization device can also include/access a virtual assistant Al (e.g. similar to or utilizing Amazon Alexa®, Google Assistant®, etc.). The virtual assistant Al can reside in a cloud-computing platform. The virtual assistant Al can alert users when stored items are due for use, past expiration, etc. The virtual assistant Al can also maintain an inventory that a user can access via verbal queries to the virtual assistant via a mobile application interface.

In some examples, to determine the fresh food inventory in restaurants, a digital camera in ultra-violet food sterilization device a can capture digital images of the food inside containers. A mobile device with an ultra-violet food sterilization application can also enable users to capture digital images of the food inside containers. In another example, users can manually enter the type of food manually via a touch screen integrated in the ultra-violet food sterilization device. This information can be tracked locally in the ultra-violet food sterilization device (e.g. in a computer system in ultra-violet food sterilization device) and/or communicated to a server-side system inventory system for managing tracking and notifications to users (e.g. via push notifications, dashboard views, etc.). For example, the digital images (and/or various metadata such as date, location, ultra-violet food sterilization device settings, etc.) can be sent to our server to be processed to determine the type of food. Then, the data and/or metadata can be communicated to users-via a mobile app or a management dashboard for restaurants (e.g. the expected expiry date of fresh food, the amount of food that hasn't been consumed before the expiry date (e.g. wasted food) and shopping list suggestions, etc.).

These digital images can be accessible to users when accessing the inventory system. The application can manage a QR code reader and then generate a receipt for time of vacuum/UV process as well. Application software can send notification to the when food items are expiring and when added. Application software can track the location of the food container and communicate this location to the user (e.g. user GPS data, simultaneous localization, and mapping, etc.). In this way no need for a manual labelling of the transparent container. The ultra-violet food sterilization device and/or transparent containers can include Wi-Fi systems that communicate with the application (e.g. via the Internet, a LAN, a cellular data network and/or various cloud-computing platforms). In one example, the ultra-violet food sterilization device can autonomously move and navigate a restaurant and food preparation/storage areas. According, the ultra-violet food sterilization device can include various systems (e.g. gyroscopes, camera, radar, and laser (laser distance sensor or LDS) guided systems, etc.) to create a floor plan, which can be permanently stored for more efficiency, and updated with information on areas which can be traversed as well as the current location of the user and/or refrigerators to store transparent containers in.

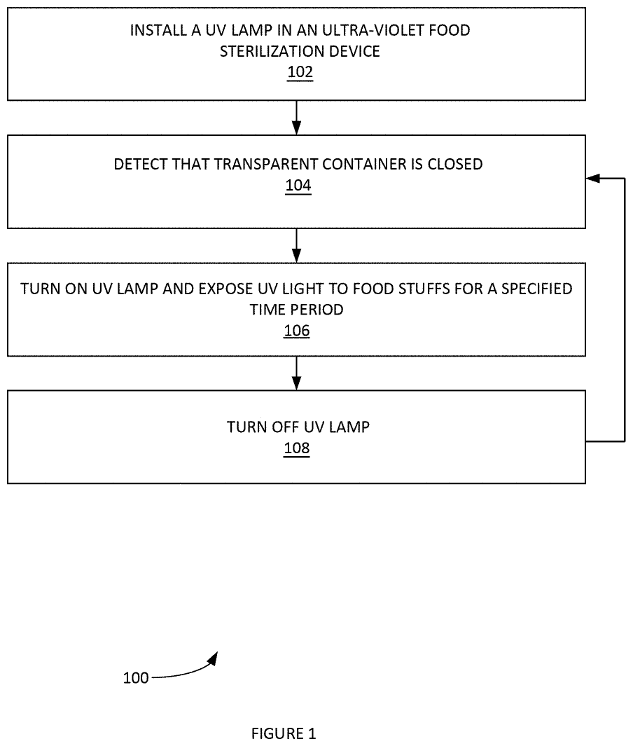

FIG. 1 illustrates an example process 100 for automating operation of a UV light lamp, according to some embodiments. In step 102, process 100 provides the installation of a UV light lamp in an ultra-violet food sterilization device. Example UV light lamp systems are described infra. It is noted that UV light can be installed inside the ultra-violet food sterilization device. Users can only place the container inside the ultra-violet food sterilization device.

In step 104, process 100, can detect that the transparent container is locked in the ultra-violet food sterilization device. Detecting that the transparent container is locked can indicate that it is safe to turn on the UV lamp for a specified period of time (e.g. one minute, etc.). The ultra-violet food sterilization device can detect that the container has been placed through a load sensor. The load sensor measures a weight of the food item.

Simultaneously, the ultra-violet food sterilization device can capture an image of the stored food via a built-in camera. The image can be sent to our server to be processed via our computer vision model to determine the type of food inside the container. Lastly, the fresh food inventory data along with the shelf-life expectancy can be communicated to the user via our mobile application. The fresh food inventory data comprises the weight of the food item. It is noted that ultra-violet food sterilization device can have a Wi-Fi module and can be connected to the home router. If a connectivity issue occurred, the collected information (e.g. food weight+image) can be stored temporarily in the ultra-violet food sterilization device memory until it's successfully sent to the server.

In step 106, when the condition(s) specified in step 104 are satisfied, process 100 can turn on UV lamp and expose UV light to food stuffs. In this step, a UV-C lamp and vacuuming pump can turn on simultaneously to sterilize food and seal the container.

In step 108, process 100 can detect that time period for sterilization is passed and/or the transparent container is in an unlocked state and turn off UV lamp. In this step, process 100 can turn off the UV-C lamp and the vacuum pump.

### Example Systems

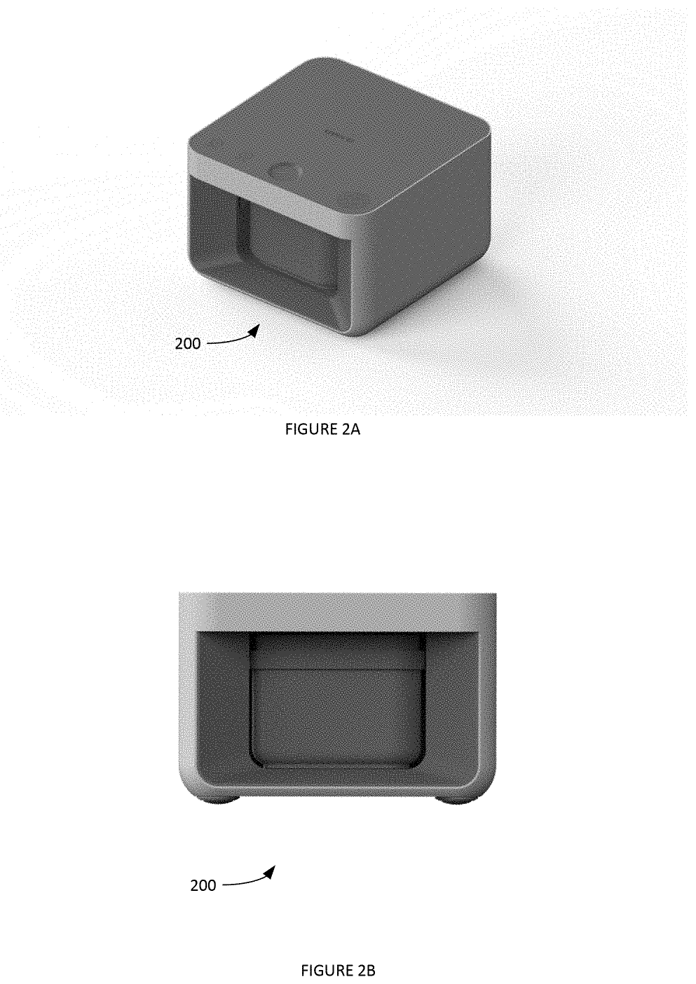

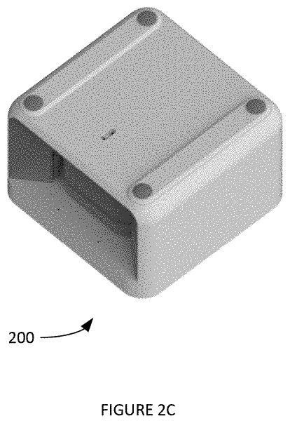

FIGS. 2 A-C illustrate an example ultra-violet food sterilization device 200, according to some embodiments. Ultra-violet food sterilization device 200 can include, inter alia: a UV lamp tube, power source, attachment devices, display, etc. Ultra-violet food sterilization device 200 can be a household product is in the shape of a square prism. The edges of the surfaces except the upper surface can be rounded. An offset of the rounded corners in the top view forms a pill-shaped piece. An interface of the ultra-violet food sterilization device 200 can include various logos, buttons, lights, and speaker apertures, etc. A circle can be formed by the speaker apertures and the round logo on the far left are offset of the rounded edges of the ultra-violet food sterilization device 200. A front surface of the ultra-violet food sterilization device 200 is cut from the rounded corners to leave some margin at the top. There is a space where the food container can be placed in the cut area. The surface between the cut edges and this gap is shaped at an angle in order to align the food container towards the gap. The pill-shaped structure formed by continuing the roundness of the rounded corners under the ultra-violet food sterilization device 200 and the spherical rubber piece cut at both ends ensure the ultra-violet food sterilization device to stand on a hard surface without slipping. Ultra-violet food sterilization device 200 can be used in a domestic context in some examples.

It is noted that, while present example illustrate use of an ultra-violet food sterilization device 200, ultra-violet food sterilization devices can be utilized in various food storage systems (e.g. freezer, personal food transport carriers (e.g. lunch boxed, etc.), etc.). Moreover, ultra-violet food sterilization device can be used to preserve various medicines, flowers and other items that are susceptible to spoilage by bacteria, viruses, etc. It is noted that in some examples, the ultra-violet food sterilization device 200 can be designed to be placed in a kitchen cabinet, while containers can be stored (e.g. inside a refrigerator) after using the device.

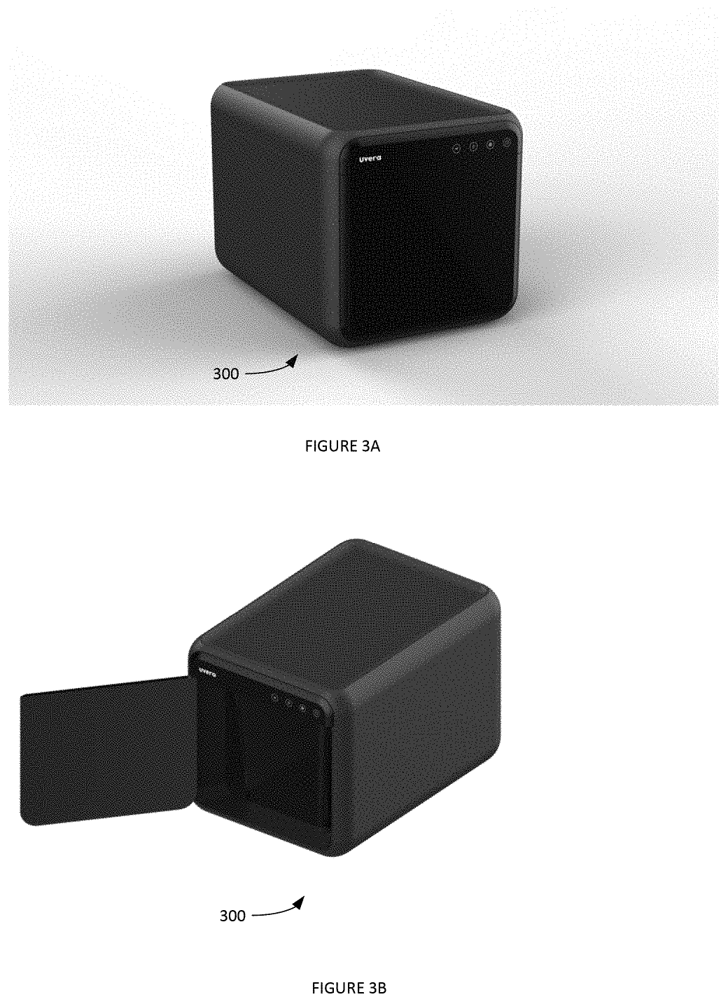

FIGS. 3 A-B illustrate another example ultra-violet food sterilization device, according to some embodiments. Ultra-violet food sterilization device 300 can be used in a restaurant and/or other enterprise-based context. Ultra-violet food sterilization device 300 can be a restaurant product. Ultra-violet food sterilization device 300 can be in the shape of a rectangular prism with rounded corners. The front surface can be separated by cutting this shape from the rounded surface and forms a black part. As shown, the black piece can be divided by a horizontal line with a small piece at the top and a large piece below. The upper black area with bright white logos forms the ultra-violet food sterilization device 300 interface. A larger black piece at the bottom can be the door of the ultra-violet food sterilization device 300. When the door is opened, a rectangular prism cavity is inside. The food storage container can be placed in this area. Areas outside of this cavity have trough-shaped angled surfaces to align the container towards the cavity. The upper surface of the ultra-violet food sterilization device 300 has been cut from the rounded area. The cut area can be customized as a pit that matches the bottom surface of another specified ultra-violet food sterilization device. In this way, multiple ultra-violet food sterilization devices can be stacked vertically.

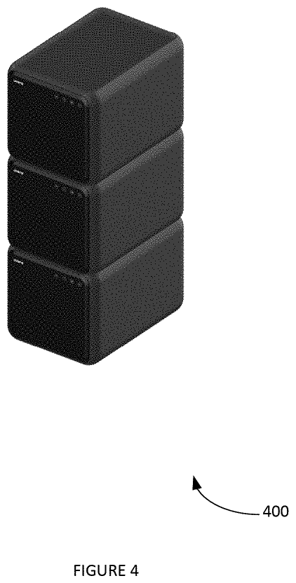

FIG. 4 illustrates a stacking of three ultra-violet food sterilization devices, according to some embodiments. The three ultra-violet food sterilization devices can be mobile and/or self-propelled. The three ultra-violet food sterilization devices can include rechargeable power sources, computing systems, networking systems, etc.

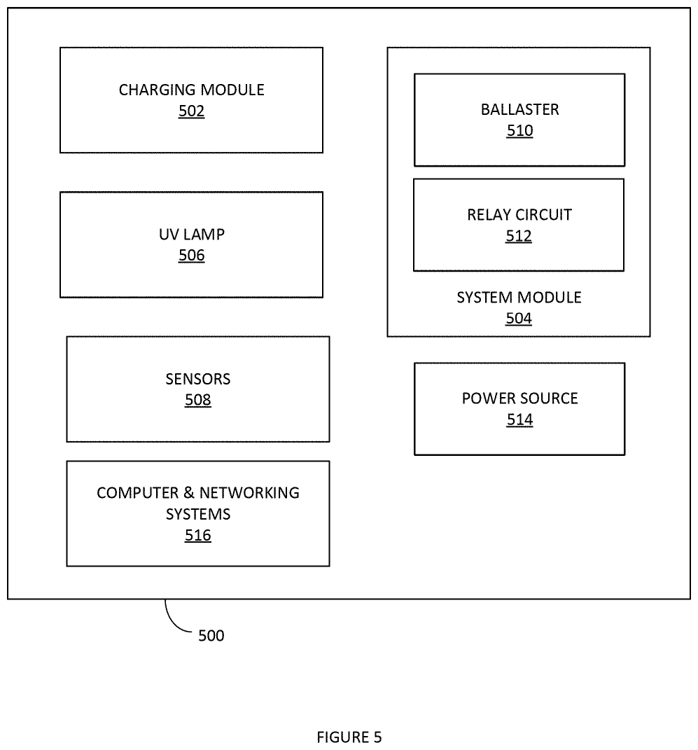

FIG. 5 illustrates an example schematic of an ultra-violet food sterilization device 500, according to some embodiments. Ultra-violet food sterilization device 500 can be used to implement ultra-violet food sterilization device 200 supra. Ultra-violet food sterilization device 500 can charging module 502. Ultra-violet food sterilization device 500 can include various power source(s) 514 (e.g. power cord, rechargeable batteries, etc.). Charging module 502 can manage charging of the rechargeable batteries and/or communicate rechargeable battery state to a display, computer, and networking systems 516, etc. It is noted that ultra-violet food sterilization device 500 is configured to be rechargeable and to be easily charged using any commercial power bank. In one example, ultra-violet food sterilization device 500 uses lithium-ion batteries due to their high capacity and operation at low temperatures. A lithium-ion battery supply the circuit with 11.1V can be utilized. The power bank supply can be 5V. Therefore, ultra-violet food sterilization device 500 can use the 5V-12V step up converter to charge the battery using the 5V power bank. Ultra-violet food sterilization device 500 can include a vacuum pump. Ultra-violet food sterilization device 500 can include various self propelling and navigation systems discussed supra. Ultra-violet food sterilization device 500 can include various Wi-Fi and/or other computer networking systems and computer processor(s).

Computer and networking system 516 can include various software modules for managing operation of ultra-violet food sterilization device 500, formatting sensor information and/or other ultra-violet food sterilization device state data across a computer network to a server, managing user alerts, analyzing data from sensors 508, managing operation of UV lamp 506 (e.g. via system module 504), etc. (e.g. in addition to taking images from camera).

System module 504 can operate UV lamp 506 using ballaster 510 and relay circuit 512. Ballaster can be an electrical ballast. System module 504 include the circuits to manage the UV lamp. In one example, the UV lamp can be a Philips TUV PL-L 36W UVC lamp. However, this lamp uses a voltage of 110V AC to operate, and an example battery supplies may be 12V DC. Therefore, system module 504 can includes an inverter block that is composed of two parts. A DC/AC inverter can be included to convert the battery DC power to AC. System module 504 can include a voltage transformer to step-up the 12V coming from the battery to 110V-220V so it matches the lamp voltage requirement. The voltage coming from the inverter block goes to two parts: ballaster 510 and relay circuit 512.

Ballaster 510 can be used to regulate the current coming from the inverter and provides sufficient voltage to start the lamps. The ballast is used as part of the circuit as the lamp requires high voltage to establish an arc between its electrodes and that is only for the first few seconds, then this voltage must be reduced and the current can be regulated to produce a steady current flow. The ballaster output pins can be connected to 4-pin socket that matches a TUP PL lamp connection requirement.

Relay circuit 512 can be a relay module that contains the controller or it may be a circuit containing CMOS. Relay circuit 512 can be used to turn on/off the lamp. Relay circuit 512 can also include a Wi-Fi and/or Bluetooth modules to enable the remote control of the device using the mobile application. The LM35 or DHT11 temperature and humidity module(s) can be connected to the relay block to feed the controller with the sensors readings and send them to the application via the Wi-Fi module.

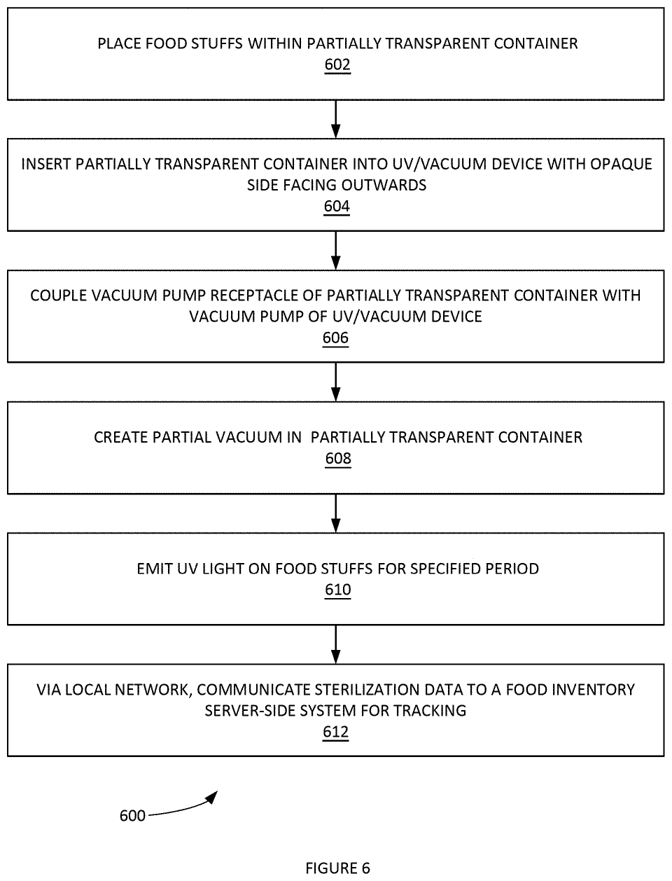

FIG. 6 illustrates an example process 600 for operating an ultra-violet food sterilization device, according to some embodiments. In step 602, food stuffs can be placed within a partially transparent container. In step 604, the partially transparent container can be inserted into a UV/vacuum device (e.g. Ultra-violet food sterilization device 500, etc.) with opaque side facing outwards. In step 606, process 600 can couple vacuum pump receptacle of partially transparent container with vacuum pump of UV/vacuum device. In step 608, process 600 can couple vacuum pump receptacle of partially transparent container with vacuum pump of UV/vacuum device. In step 610, process 600 can cause the device to emit UV light on food stuffs for specified period. In step 612, process 600 can, via local network, communicate sterilization data to a food inventory server-side system for tracking.

### Additional Example Systems

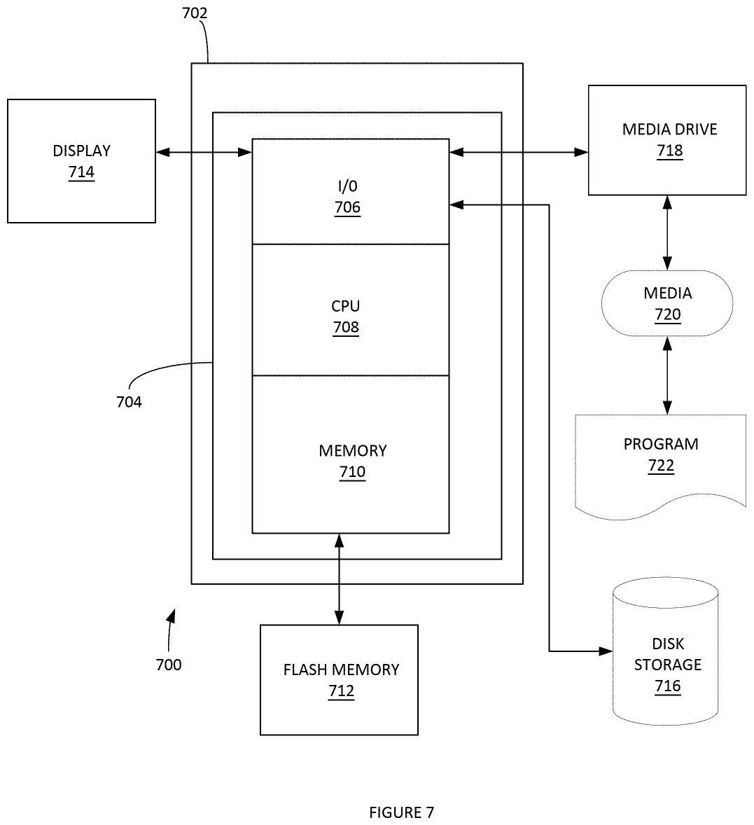

FIG. 7 depicts an exemplary computing system 700 that can be configured to perform any one of the processes provided herein. In this context, computing system 700 may include, for example, a processor, memory, storage, and I/O devices (e.g., monitor, keyboard, disk drive, Internet connection, etc.). However, computing system 700 may include circuitry or other specialized hardware for carrying out some or all aspects of the processes. In some operational settings, computing system 700 may be configured as a system that includes one or more units, each of which is configured to carry out some aspects of the processes either in software, hardware, or some combination thereof.

FIG. 7 depicts computing system 700 with a number of components that may be used to perform any of the processes described herein. The main system 702 includes a motherboard 704 having an I/O section 706, one or more central processing units (CPU) 708, and a memory section 710, which may have a flash memory card 712 related to it. The I/O section 706 can be connected to a display 714, a keyboard and/or other user input (not shown), a disk storage unit 716, and a media drive unit 718. The media drive unit 718 can read/write a computer-readable medium 720, which can contain programs 722 and/or data. Computing system 700 can include a web browser. Moreover, it is noted that computing system 700 can be configured to include additional systems in order to fulfill various functionalities. Computing system 700 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### Additional Example Horizontal Configuration Embodiment

FIG. 8 illustrates an example horizontal configuration of ultra-violet food sterilization devices, according to some embodiments. It is noted that the ultra-violet food sterilization device units can be connected horizontally instead of stacking them vertically (e.g. as discussed supra). In some storage context it may be easier for users to place industrial size containers in a cabinet-level device. In one example, the ultra-violet food sterilization device is designed to be placed in a kitchen cabinet, while containers can be stored (e.g. inside a refrigerator, etc.) after using the ultra-violet food sterilization device. These digital images can be sent to a server to be processed to determine the type of food. Then, specified data can be communicated to users (e.g. via a mobile applications and/or a management dashboard for restaurants (such as the expected expiry date of fresh food)), the amount of food that has not been consumed before the expiry date (e.g. wasted food) and shopping list suggestions. In one example, to determine the fresh food inventory in restaurants, digital images can be used to capture the food inside containers via a built-in camera, or allow users to enter the type of food manually via a touch screen integrated in the device.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A method for automating operation of an ultraviolet (UV) light lamp and vacuum pump comprising:
providing a UV light lamp in the ultra-violet food sterilization device;
providing a vacuum pump in the ultra-violet food sterilization device;
detecting that a food-item container is placed inside the ultra-violet food sterilization device, wherein the food-item container comprises a material that is transparent to UV light, and wherein the food-item container comprises a vacuum-pump receptacle;
turning on a UV light lamp for a specified period of time; and
with a vacuum pump, generating a specified partial vacuum within the food-item container.

2. The method of claim 1, wherein the UV light can be installed inside the ultra-violet food sterilization device.

3. The method of claim 1, wherein the UV light lamp uses a Band-C of the UV light.

4. The method of claim 3, wherein the UV light ranges between 200 nm-280 nm.

5. The method of claim 1, ultra-violet food sterilization device detects that the food-item container has been placed through a load sensor.

6. The method of claim 1, wherein the ultra-violet food sterilization device captures a digital image of the stored food via a built-in camera in the ultra-violet food sterilization device.

7. The method of claim 6 further comprising:
with at least one computer vision model, determining the type of food inside the food-item container.

8. The method of claim 7 further comprising:
based on the type of food inside the food-item container, determining shelf-life expectancy of the stored food.

9. The method of claim 8 further comprising:
maintaining a fresh food inventory data of the stored food in a database; and
pushing, via an electronic message, the shelf-life expectancy of the stored food and the fresh food inventory data to a mobile device application.

10. The method of claim 9, wherein the mobile device application comprises a virtual assistant Al as a software agent that is used to access the fresh food inventory data.

11. The method of claim 10, wherein the UV-C lamp and vacuuming pump are turned on simultaneously to sterilize food and seal the food container.

12. A food sterilization and storage system comprising:
an ultra-violet food sterilization device comprising:
a UV lamp used to sterilize a stored food in a transparent food-item container;
the transparent food-item container used to store the stored food in a specified partial vacuum, wherein the transparent food-item container comprises a vacuum pump receptacle;
a vacuum for generating the partial vacuum in the transparent food-item container; and
a load sensor for detecting the presence of the transparent food-item container in an operative location of the ultra-violet food sterilization device.

13. The system of claim 11, wherein the ultra-violet food sterilization device comprises a digital camera used obtain one or more images of the stored food when the load sensor detects the presence of the transparent food-item container.

14. The system of claim 12, wherein the ultra-violet food sterilization device comprises a local computer processor and Wi-Fi system to communicatively couple with a remote server system.

15. The system of claim 13, wherein the ultra-violet food sterilization device communicates the digital image of the stored food to the remote server for computer-vision processing to determine a type of food of the stored food.

16. The system of claim 14, wherein the transparent food-item container is removable from the ultra-violet food sterilization device for storage in a refrigerator.

17. The system of claim 15 further comprising:
a plurality of ultra-violet food sterilization devices comprising an interlocking interface between each ultra-violet food sterilization device of the plurality of the ultra-violet food sterilization devices in a stackable configuration.

18. The system of claim 16, wherein a bottom ultra-violet food sterilization device comprises four wheels on a bottom surface such that the plurality of ultra-violet food sterilization device in a stacked state are rollable.

19. The system of claim 18, wherein the bottom ultra-violet food sterilization device maintains a maintaining a fresh food inventory data of the stored food in a database and interfaces with a mobile device application, and wherein the mobile device application comprises a virtual assistant Al as a software agent that is used to access the fresh food inventory data.

20. The system of claim 19,
wherein the load sensor measures a weight of the food item and wherein the fresh food inventory data comprises the weight of the food item,
wherein the mobile device comprises a speaker and a microphone, and
wherein the virtual assistant Al communicates to the user utilizing the speaker for output and the microphone for input.
